(19) United States
(12) Patent Application Publication
(10) Pub. No.: US 2026/0085171 A1
(43) Pub. Date: Mar. 26, 2026

(54) COMPOSITION, SHEET-LIKE PRODUCT, MULTILAYER BODY, METHOD FOR MANUFACTURING COMPOSITION, AND CHIP-TYPE MULTILAYER ELECTRONIC COMPONENT

(71) Applicant: Murata Manufacturing Co., Ltd., Kyoto-fu (JP)

(72) Inventors: Ayumi YAMAMOTO, Nagaokakyo-shi (JP); Reiji OZAWA, Nagaokakyo-shi (JP)

(73) Assignee: Murata Manufacturing Co., Ltd., Kyoto-fu (JP)

(21) Appl. No.: 19/328,542

(22) Filed: Sep. 15, 2025

(30) Foreign Application Priority Data
Sep. 24, 2024 (JP) 2024-165348

(51) Int. Cl. C08K 5/12; B32B 7/03; B32B 27/36; C04B 14/36; C08J 3/18; C08J 3/20

(52) U.S. Cl. CPC C08K 5/12; B32B 7/03; B32B 27/36; C04B 14/363; C08J 3/18; C08J 3/203; B32B 2255/10; B32B 2255/20; B32B 2255/26; B32B 2305/342; B32B 2305/80; B32B 2307/50; B32B 2307/7376; C08J 2331/04

(57) ABSTRACT

A composition contains an inorganic powder, a binder resin, and a glass transition temperature modifier. The glass transition temperature modifier contains a compound having a structure represented by general formula (1) below

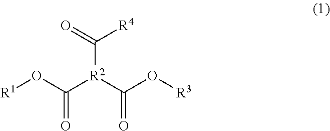

wherein (In general formula (1), R¹ is a hydrogen atom or a C1-C12 hydrocarbon group. In general formula (1), R² is a C1-C12 hydrocarbon group. In general formula (1), R³ is a hydrogen atom or a C1-C12 hydrocarbon group. In general formula (1), R⁴ is a hydrogen atom or a C1-C12 hydrocarbon group).

### CROSS-REFERENCE TO RELATED APPLICATION

This application claims benefit of priority to Japanese Patent Application No. 2024-165348, filed Sep. 24, 2024, the entire content of which is incorporated herein by reference

### BACKGROUND

### Technical Field

The present disclosure relates to a composition, a sheet-like product, a multilayer body, a method for manufacturing the composition, and a chip-type multilayer electronic component.

### Background Art

In general, ceramic green sheets for multilayer ceramic electronic components are produced by forming a slurry containing ceramic particles and a binder resin into a sheet shape. For example, vinyl acetate resin is used as the binder resin.

A plasticizer is added to the slurry to improve formability when forming the slurry into a sheet shape or to improve adhesion when stacking the formed sheet-like products. The addition of the plasticizer lowers the glass transition temperature (Tg) of the binder resin to improve the plasticity of the slurry. Phthalate esters have been used as such plasticizers.

Japanese Unexamined Patent Application Publication No. 2002-179925 discloses a ceramic green sheet containing a ceramic powder, a binder resin, a plasticizer added in an amount exceeding the saturation level for the binder resin, and a solvent, and discloses the use of phthalate esters as plasticizers.

### SUMMARY

The use of the plasticizers described in Japanese Unexamined Patent Application Publication No. 2002-179925 lowers the Tg of the binder resin, but there is a need to increase the Tg of the binder resin from the viewpoint of formability or other properties. The phthalate esters used as plasticizers in Japanese Unexamined Patent Application Publication No. 2002-179925 are concerned about their effects on human health, and the use of such compounds has a significant environmental impact.

The present disclosure aims at providing a composition containing a glass transition temperature modifier that can increase the Tg of a binder resin.

The composition of the present disclosure contains an inorganic powder, a binder resin, and a glass transition temperature modifier, wherein the glass transition temperature modifier contains a compound having a structure represented by general formula (1) below:

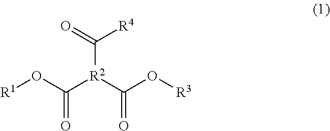

(In general formula (1), R¹ is a hydrogen atom or a C1-C12 hydrocarbon group.
In general formula (1), R² is a C1-C12 hydrocarbon group.
In general formula (1), R³ is a hydrogen atom or a C1-C12 hydrocarbon group.
In general formula (1), R⁴ is a hydrogen atom or a C1-C12 hydrocarbon group).

A sheet-like product of the present disclosure contains the composition of the present disclosure.

A multilayer body of the present disclosure includes the sheet-like products of the present disclosure stacked on top of one another.

A method for manufacturing a composition of the present disclosure includes a grinding step of grinding an inorganic material into an inorganic powder and a mixing step of mixing the inorganic powder, a binder resin, and a glass transition temperature modifier, wherein the glass transition temperature modifier contains a compound having a structure represented by general formula (1) below:

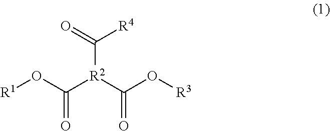

(In general formula (1), R¹ is a hydrogen atom or a C1-C12 hydrocarbon group.
In general formula (1), R² is a C1-C12 hydrocarbon group.
In general formula (1), R³ is a hydrogen atom or a C1-C12 hydrocarbon group.
In general formula (1), R⁴ is a hydrogen atom or a C1-C12 hydrocarbon group).

A chip-type multilayer electronic component of the present disclosure includes a base body including a plurality of ceramic fired sheets stacked on top of one another, wherein the base body has a striped pattern perpendicular to the stacking direction when viewed from the side surface.

According to the present disclosure, a composition containing a glass transition temperature modifier that can increase the Tg of a binder resin can be provided.

### BRIEF DESCRIPTION OF THE DRAWINGS

FIG. 1A is a schematic cross-sectional view of an example of a sheet-like product of the present disclosure;

FIG. 1B is an enlarged view of an area enclosed by the dashed line in FIG. 1A;

FIG. 2A is a schematic view of an example of a process for producing a multilayer body using the sheet-like products of the present disclosure;

FIG. 2B is a schematic view of an example of the process for producing a multilayer body using the sheet-like products of the present disclosure;

FIG. 3 is a schematic side view of an example of a base body including a plurality of fired sheets stacked on top of one another; and

FIG. 4 is a graph of the loss factor (Tan δ) in the dynamic viscoelasticity measurement in Example according to the present disclosure.

### DETAILED DESCRIPTION

The composition, the sheet-like product, the multilayer body, the method for manufacturing the composition, and the chip-type multilayer electronic component of the present disclosure will be described below.

However, the present disclosure is not limited to the following embodiments and can be modified as appropriate and applied without departing from the spirit of the present disclosure. A combination of two or more individual preferred components of the present disclosure described in the following embodiments is also within the present disclosure.

The figures described below illustrate schematic views, and the size, the aspect ratio, and the like are not necessarily drawn to scale.

It should be understood that the embodiments described below are illustrative only, and partial replacements or combinations of the components described in the embodiments are optionally possible.

The composition of the present disclosure contains an inorganic powder, a binder resin, and a glass transition temperature modifier, wherein the glass transition temperature modifier contains a compound having a structure represented by general formula (1) below:

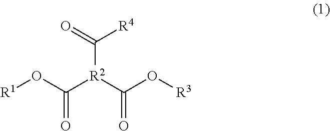

(In general formula (1), R¹ is a hydrogen atom or a C1-C12 hydrocarbon group.
In general formula (1), R² is a C1-C12 hydrocarbon group.
In general formula (1), R³ is a hydrogen atom or a C1-C12 hydrocarbon group.
In general formula (1), R⁴ is a hydrogen atom or a C1-C12 hydrocarbon group).

The compound represented by general formula (1) above can increase the Tg of the binder resin. The composition containing the inorganic powder, the binder resin, and the glass transition temperature modifier can thus easily adjust plasticity and improve formability. Therefore, the composition of the present disclosure can be suitably used to form sheet-like products. The formed sheet-like products are less likely to deform.

Furthermore, a multilayer body produced by stacking the sheet-like products is unlikely to deform. Therefore, when the multilayer body is sintered to produce a base body of a chip-type multilayer electronic component, variations in the appearance quality of the base body and in electrical characteristics are reduced. As a result, the yield is improved.

The principle that enables the Tg of the binder resin to be increased may be as described below.

A binder resin is typically composed of molecules with polar groups.

Since the compound having the structure represented by general formula (1) above is bulky, the compound having the structure represented by general formula (1) above is unlikely to orient toward the polar groups of the molecules of the binder resin. Therefore, the compound having the structure represented by general formula (1) above is less likely to penetrate the spaces between molecules of the binder resin. Therefore, the molecules of the binder resin tend to associate with each other. This increases the Tg of the binder resin.

When R¹, R², R³, and R⁴ have the above structure, the compound having the structure represented by general formula (1) is easy to handle because the compound is liquid at room temperature (25° C.).

Each component of the composition of the present disclosure will be described below.

### Inorganic Powder

In the composition of the present disclosure, the inorganic powder may be a ceramic powder. In this case, a ceramic green sheet can be produced by forming the composition of the present disclosure into a sheet-like product.

In the composition of the present disclosure, the inorganic powder preferably contains at least one selected from the group consisting of zirconia, titania, alumina, barium titanate, ferrite, PZT, zinc oxide, glass, and glass ceramics. These materials are suitable for manufacturing the chip-type multilayer electronic component using the composition of the present disclosure.

In the composition of the present disclosure, the inorganic powder preferably, but not necessarily, has an average particle size of 0.01 μm or more and 50 μm or less (i.e., from 0.01 μm to 50 μm).

In the composition of the present disclosure, the percentage of the inorganic powder is preferably 65 wt % or more and 96 wt % or less (i.e., from 65 wt % to 96 wt %), more preferably 74 wt % or more and 95 wt % or less (i.e., from 74 wt % to 95 wt %).

As described below in detail, the composition of the present disclosure is used to produce sheet-like products. The sheet-like products are stacked and sintered to form a base body of the chip-type multilayer electronic component.

When the percentage of the inorganic powder is within the above range, the produced base body has suitable density and strength to function as part of the chip-type multilayer electronic component.

### Binder Resin

In the composition of the present disclosure, the binder resin preferably contains at least one selected from the group consisting of polyvinyl acetate, polyvinyl butyral, polyvinyl alcohol, acrylic, urethane, more preferably contains polyvinyl acetate. These binder resins can bond the inorganic powder particles together and are thus suitable for forming the composition of the present disclosure into a predetermined shape.

In particular, when the binder resin is polyvinyl acetate, the compound having the structure represented by general formula (1) above is less likely to orient toward the acetyloxy groups of polyvinyl acetate molecules because of its bulkiness.

The compound having the structure represented by general formula (1) above is thus unlikely to penetrate the spaces between polyvinyl acetate molecules, so that the polyvinyl acetate molecules easily associate with each other. This increases the Tg of polyvinyl acetate.

Therefore, the glass transition temperature modifier can adjust the Tg of polyvinyl acetate and improves the formability of the composition of the present disclosure.

In the composition of the present disclosure, the binder resin is preferably contained in an emulsified state. In this case, the inorganic powder does not concentrate locally and is easily dispersed in the composition of the present disclosure.

In the composition of the present disclosure, the amount of the binder resin relative to 100 parts by weight of the inorganic powder is preferably 5 parts by weight or more and 50 parts by weight or less (i.e., from 5 parts by weight to 50 parts by weight), more preferably 10 parts by weight or more and 30 parts by weight or less (i.e., from 10 parts by weight to 30 parts by weight), still more preferably 10 parts by weight or more and 20 parts by weight or less (i.e., from 10 parts by weight to 20 parts by weight).

If the amount of the binder resin is less than 5 parts by weight relative to 100 parts by weight of the inorganic powder, the amount of the binder resin is so small that it is difficult for the inorganic powder particles to bond sufficiently with each other. As a result, when the composition is formed into a predetermined shape, the formed product easily breaks.

If the amount of the binder resin exceeds 50 parts by weight relative to 100 parts by weight of the inorganic powder, the amount of the inorganic powder is relatively small, and large dimensional changes during firing result in an increase in shrinkage-induced stress, which in turn increases the likelihood of crack formation.

### Glass Transition Temperature Modifier

In the composition of the present disclosure, R¹ in the structure represented by general formula (1) may be a linear or branched C1-C12 hydrocarbon group. R¹ may include an unsaturated bond or may be composed only of saturated bonds, preferably composed only of saturated bonds.

When R¹ includes an unsaturated bond, the unsaturated bond restricts intramolecular rotation, resulting in a rigid planar structure in the region where the unsaturated bond is present. When R¹ is composed only of saturated bonds, the intramolecular rotation is not restricted, and the increase in Tg is slower than when an unsaturated bond is included. The presence or absence of an unsaturated bond is selected depending on the desired Tg. From a viewpoint other than Tg, the glass transition temperature modifier is more materially stable and easier to handle as a material when R¹ is composed only of saturated bonds than when R¹ includes an unsaturated bond. R¹ is preferably a 2-ethylhexyl group.

In the composition of the present disclosure, R² in the structure represented by general formula (1) may be a linear, branched, or cyclic C1-C12 hydrocarbon group.

When R² is a cyclic hydrocarbon group, the cyclic hydrocarbon group may be a heterocyclic ring.

R² is preferably a benzene ring.

R² may include an unsaturated bond or may be composed only of saturated bonds.

In the composition of the present disclosure, R³ in the structure represented by general formula (1) may be a linear or branched C1-C12 hydrocarbon group. R³ may include an unsaturated bond or may be composed only of saturated bonds, preferably composed only of saturated bonds. R³ is preferably a 2-ethylhexyl group.

In the composition of the present disclosure, R⁴ in the structure represented by general formula (1) may be a linear or branched C1-C12 hydrocarbon group. R⁴ may include an unsaturated bond or may be composed only of saturated bonds, preferably composed only of saturated bonds. R⁴ is preferably a 2-ethylhexyl group.

In the composition of the present disclosure, the compound having the structure represented by general formula (1) may contain a derivative of a tricarboxylic acid, such as trimellitic acid, aconitic acid, propane-1,2,3-tricarboxylic acid, and cyclohexane-1,2,4-tricarboxylic acid.

Examples of the derivative of such a tricarboxylic acid include trimellitic acid alkyl esters, aconitic acid alkyl esters, propane-1,2,3-tricarboxylic acid alkyl esters, and cyclohexane-1,2,4-tricarboxylic acid alkyl esters.

In this case, the structure represented by general formula (1) may have a carboxyl group residue (i.e., R¹, R³, or R⁴ is a hydrogen atom).

In the composition of the present disclosure, the compound having the structure represented by general formula (1) below is preferably tris(2-ethylhexyl) trimellitate, which is represented by general formula (2) below:

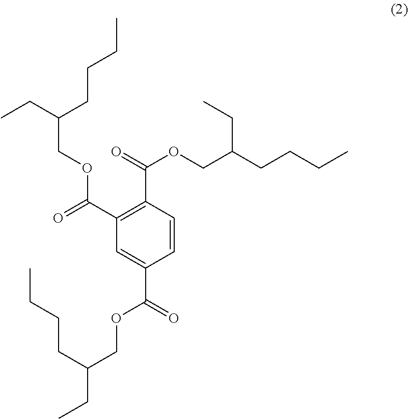

The above tricarboxylic acid alkyl esters are inexpensive and can reduce the costs for manufacturing the composition of the present disclosure.

In the composition of the present disclosure, the amount of the glass transition temperature modifier relative to 100 parts by weight of the inorganic powder is preferably 0.01 parts by weight or more and 5 parts by weight or less (i.e., from 0.01 parts by weight to 5 parts by weight), more preferably 0.1 parts by weight or more and 1.0 part by weight or less (i.e., from 0.1 parts by weight to 1.0 part by weight).

If the amount of the glass transition temperature modifier relative to 100 parts by weight of the inorganic powder is less than 0.01 parts by weight, the Tg of the binder resin is unlikely to increase sufficiently.

If the amount of the glass transition temperature modifier relative to 100 parts by weight of the inorganic powder exceeds 5 parts by weight, the effect of increasing the Tg of the binder resin approaches its maximum, which is uneconomical.

### Solvent

The composition of the present disclosure may further contain a solvent.

Examples of the solvent include diethylene glycol monobutyl ether, diethylene glycol monobutyl ether acetate, texanol, eugenol, terpineol, dihydroterpineol, benzyl alcohol, ethanol, isophorone, methyl ethyl ketone, and diethyl ketone. These solvents are useful in uniformly mixing the inorganic powder, the binder resin, and the plasticizer in the composition of the present disclosure.

In the composition of the present disclosure, the percentage of the solvent is preferably 0.05 wt % or more and 20 wt % or less (i.e., from 0.05 wt % to 20 wt %).

### Other Additives

The composition of the present disclosure may further contain a dispersant, a plasticizer, a defoamer, and a wetting agent as other additives.

Examples of the dispersant include ammonium polycarboxylate and maleic anhydride-styrene copolymer.

Examples of the plasticizer include diglycerol, polyglycerol, and hydroxy acid alkyl esters.

Examples of the defoamer include polyalkylene glycol, dimethylpolysiloxane, and octadecanol.

Examples of the wetting agent include polyalkylene glycol and polyglycerol.

### Proportion of Each Component and Like

The composition of the present disclosure preferably contains 5 parts by weight or more and 50 parts by weight or less (i.e., from 5 parts by weight to 50 parts by weight) of the binder resin relative to 100 parts by weight of the inorganic powder and 0.01 parts by weight or more and 5 parts by weight or less (i.e., from 0.01 parts by weight to 5 parts by weight) of the glass transition temperature modifier relative to 100 parts by weight of the inorganic powder, more preferably contains 10 parts by weight or more and 30 parts by weight or less (i.e., from 10 parts by weight to 30 parts by weight) of the binder resin and 0.01 parts by weight or more and 5 parts by weight or less (i.e., from 0.01 parts by weight to 5 parts by weight) of the glass transition temperature modifier relative to 100 parts by weight of the inorganic powder, still more preferably contains 10 parts by weight or more and 20 parts by weight or less (i.e., from 10 parts by weight to 20 parts by weight) of the binder resin and 0.1 parts by weight or more and 1.0 part by weight or less (i.e., from 0.1 parts by weight to 1.0 part by weight) of the glass transition temperature modifier relative to 100 parts by weight of the inorganic powder.

When the composition of the present disclosure contains such proportions of the inorganic powder, the binder resin, and the glass transition temperature modifier, the Tg of the binder resin is suitably increased. The composition of the present disclosure thus has improved formability.

In the composition of the present disclosure, the weight percentage (wt %) of the binder resin relative to the weight of the glass transition temperature modifier is preferably 0.5 or more and 5000 or less (i.e., from 0.5 to 5000), more preferably 2.5 or more and 200 or less (i.e., from 2.5 to 200).

Next, a method for manufacturing the composition of the present disclosure will be described.

The method for manufacturing the composition of the present disclosure includes a grinding step of grinding an inorganic material into an inorganic powder and a mixing step of mixing the inorganic powder, a binder resin, and a glass transition temperature modifier, wherein the plasticizer contains a compound having a structure represented by general formula (1) below:

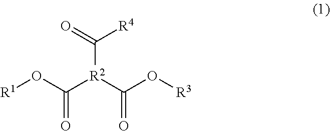

(In general formula (1), R¹ is a hydrogen atom or a C1-C12 hydrocarbon group.
In general formula (1), R² is a C1-C12 hydrocarbon group.
In general formula (1), R³ is a hydrogen atom or a C1-C12 hydrocarbon group.
In general formula (1), R⁴ is a hydrogen atom or a C1-C12 hydrocarbon group).

The use of the glass transition temperature modifier containing the compound having the structure represented by general formula (1) above can increase the Tg of the binder resin. In other words, the plasticity of the manufactured composition can be adjusted by using the glass transition temperature modifier.

In the method for manufacturing the composition of the present disclosure, the mixing step preferably involves mixing the inorganic powder, the binder resin, and the plasticizer such that 5 parts by weight or more and 50 parts by weight or less (i.e., from 5 parts by weight to 50 parts by weight) of the binder resin and 0.01 parts by weight or more and 5 parts by weight or less (i.e., from 0.01 parts by weight to 5 parts by weight) of the plasticizer are mixed relative to 100 parts by weight of the inorganic powder. The mixing step more preferably involves mixing the inorganic powder, the binder resin, and the plasticizer such that 10 parts by weight or more and 30 parts by weight or less (i.e., from 10 parts by weight to 30 parts by weight) of the binder resin and 0.01 parts by weight or more and 5 parts by weight or less (i.e., from 0.01 parts by weight to 5 parts by weight) of the plasticizer are mixed relative to 100 parts by weight of the inorganic powder, still more preferably involves mixing the inorganic powder, the binder resin, and the plasticizer such that 10 parts by weight or more and 20 parts by weight or less (i.e., from 10 parts by weight to 20 parts by weight) of the binder resin and 0.1 parts by weight or more and 1.0 part by weight or less (i.e., from 0.1 parts by weight to 1.0 part by weight) of the plasticizer are mixed relative to 100 parts by weight of the inorganic powder.

When the manufactured composition contains such proportions of the inorganic powder, the binder resin, and the glass transition temperature modifier, the Tg of the binder resin is suitably increased. The manufactured composition thus has improved formability.

Next, the chip-type multilayer electronic component produced by using the composition of the present disclosure will be described. The chip-type multilayer electronic component produced by using the composition of the present disclosure is also included in an aspect of the present disclosure.

The sheet-like products made of the composition of the present disclosure and the multilayer body including the sheet-like products stacked on top of one another are also produced in the production of the chip-type multilayer electronic component, and these sheet-like products and multilayer body are also included in aspects of the present disclosure.

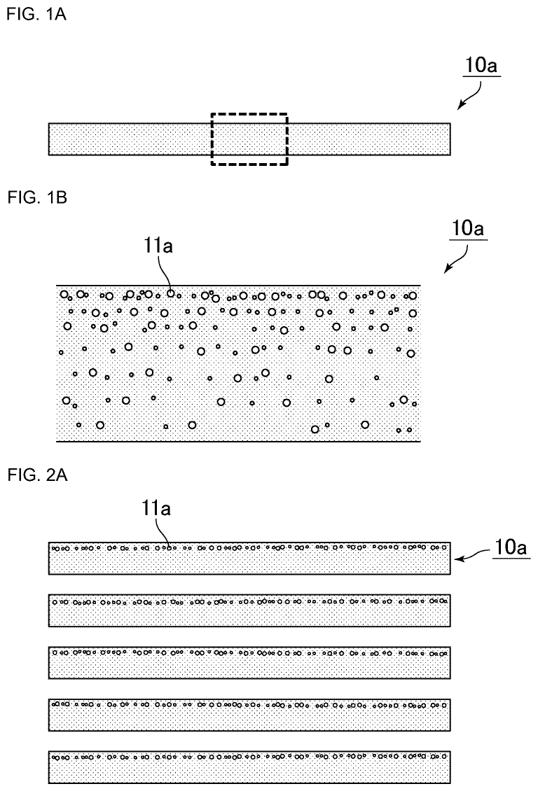

FIG. 1A is a schematic cross-sectional view of an example of a sheet-like product of the present disclosure.

FIG. 1B is an enlarged view of the area enclosed by the dashed line in FIG. 1A.

As illustrated in FIG. 1A, the composition of the present disclosure is first formed into a sheet shape to obtain a sheet-like product 10a in the production of the chip-type multilayer electronic component of the present disclosure.

The method for forming the composition of the present disclosure into a sheet shape is not limited, and a conventionally known method such as using a bar coater or printing can be employed.

As illustrated in FIG. 1B, the density of the binder resin 11a increases toward the top surface of the sheet-like product 10a in the production of the sheet-like product 10a since the binder resin has a lower specific gravity than the inorganic powder.

After forming the sheet-like product 10a, vias (not shown) may be formed in the sheet-like product 10a as necessary, and a conductive paste (not shown) may be applied to the sheet-like product 10a.

The vias and conductive paste can be formed by using conventionally known materials, and conventionally known methods can also be employed for their formation and application.

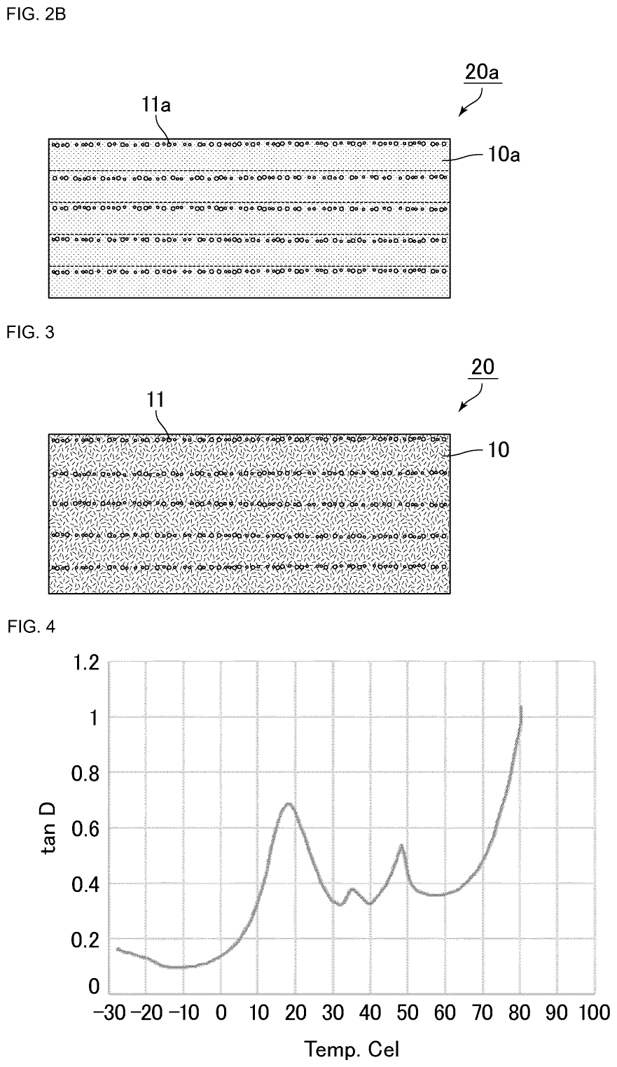

FIGS. 2A and 2B are schematic views of examples of the process for producing the multilayer body using the sheet-like product of the present disclosure.

Next, as illustrated FIG. 2A, a plurality of sheet-like products 10a are prepared.

As illustrated in FIG. 2B, the sheet-like products 10a are stacked on top of each other and pressure-bonded together to produce a mother block 20a, which is a multilayer body.

The pressure bonding conditions are not limited, and a conventionally known method can be employed.

The mother block 20a may then be cut into a predetermined shape to form a chip-like product.

The edges of the chip-like product may be further R-chamfered as necessary.

The mother block 20a and the chip-like product both correspond to the multilayer body of the present disclosure.

These multilayer bodies do not easily deform because they are made of the composition of the present disclosure. As a result, variations in electrical characteristics and in the appearance quality of the base body produced through the process described below are reduced.

Next, the chip-like product is dewaxed and fired. The sheet-like products 10a accordingly become fired sheets 10, and a base body 20 including a plurality of fired sheets 10 stacked on top of one another as illustrated in FIG. 3 can be produced.

FIG. 3 is a schematic side view of an example of the base body including a plurality of fired sheets stacked on top of one another.

The conductive paste formed on the sheet-like products 10a becomes internal electrodes during this firing.

During the firing, the binder resin 11a contained in the sheet-like products 10a is thermally decomposed to form pores 11.

As described above, the density of the binder resin 11a increases toward the top surface in the sheet-like products 10a. Therefore, the areas with a high density of the binder resin 11a will also have a high density of the pores 11. Therefore, as illustrated in FIG. 3, the pores 11 appear to be linearly formed in the direction perpendicular to the stacking direction when the base body 20 is viewed from the side surface.

As illustrated in FIG. 3, the base body 20 is composed of a plurality of fired sheets 10 stacked on top of one another, and the base body 20 thus has the striped pattern perpendicular to the stacking direction when viewed from the side surface.

The base body 20 may have, for example, an outer electrode as necessary.

The chip-type multilayer electronic component of the present disclosure can be produced by using this method.

Since the base body 20 has the striped pattern perpendicular to the stacking direction when viewed from the side surface as described above, the side surfaces of the chip-type multilayer electronic component of the present disclosure including the base body 20 can be recognized by using this striped pattern as a marking.

In other words, when observing the chip-type multilayer electronic component, an observer can recognize the surfaces with the striped pattern as the side surfaces and the surfaces without the striped pattern as the top surface or the bottom surface in the base body of the chip-type multilayer electronic component.

It is not necessary to form other identification markings on the side surfaces, top surface, and bottom surface of the base body in the chip-type multilayer electronic component of the present disclosure. The production costs can thus be reduced.

The following disclosures are described in this specification.

The disclosure (1) is a composition comprising an inorganic powder, a binder resin, and a glass transition temperature modifier, wherein the glass transition temperature modifier has a structure represented by general formula (1) below:

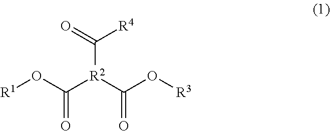

(In general formula (1), R¹ is a hydrogen atom or a C1-C12 hydrocarbon group.
In general formula (1), R² is a C1-C12 hydrocarbon group.
In general formula (1), R³ is a hydrogen atom or a C1-C12 hydrocarbon group.
In general formula (1), R⁴ is a hydrogen atom or a C1-C12 hydrocarbon group).

The disclosure (2) is the composition according to the disclosure (1), wherein the glass transition temperature modifier is a derivative of at least one tricarboxylic acid selected from the group consisting of trimellitic acid, aconitic acid, propane-1,2,3-tricarboxylic acid, and cyclohexane-1,2,4-tricarboxylic acid.

The disclosure (3) is the composition according to the disclosure (1) or (2), further comprising a solvent.

The disclosure (4) is the composition according to any one of the disclosures (1) to (3), wherein the binder resin contains at least one selected from the group consisting of polyvinyl acetate, polyvinyl butyral, polyvinyl alcohol, acrylic, urethane, polyvinyl pyrrolidone, polyethylene glycol, ethylene-vinyl acetate copolymer, and cellulose ether.

The disclosure (5) is the composition according to any one of the disclosures (1) to (4), wherein the inorganic powder contains a ceramic powder.

The disclosure (6) is the composition according to any one of the disclosures (1) to (4), wherein the inorganic powder contains at least one selected from the group consisting of zirconia, titania, alumina, barium titanate, ferrite, PZT, zinc oxide, glass, and glass ceramics.

The disclosure (7) is the composition according to any one of the disclosures (1) to (6), wherein, relative to 100 parts by weight of the inorganic powder, the binder resin is contained in an amount of 5 parts by weight or more and 50 parts by weight or less (i.e., from 5 parts by weight to 50 parts by weight), and the plasticizer is contained in an amount of 0.01 parts by weight or more and 5 parts by weight or less (i.e., from 0.01 parts by weight to 5 parts by weight).

The disclosure (8) is a sheet-like product comprising the composition according to any one of the disclosures (1) to (7).

The disclosure (9) is a multilayer body comprising a plurality of the sheet-like products according to the disclosure (8) stacked on top of one another.

The disclosure (10) is a method for manufacturing a composition, the method comprising a grinding step of grinding an inorganic material into an inorganic powder and a mixing step of mixing the inorganic powder, a binder resin, and a glass transition temperature modifier, wherein the glass transition temperature modifier contains a compound having a structure represented by general formula (1) below:

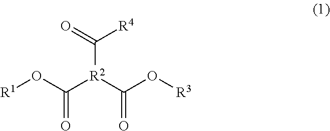

(In general formula (1), R¹ is a hydrogen atom or a C1-C12 hydrocarbon group.
In general formula (1), R² is a C1-C12 hydrocarbon group.
In general formula (1), R³ is a hydrogen atom or a C1-C12 hydrocarbon group.
In general formula (1), R⁴ is a hydrogen atom or a C1-C12 hydrocarbon group).

The disclosure (11) is the method for manufacturing a composition according to the disclosure (10), wherein the mixing step involves mixing the inorganic powder, the binder resin, and the glass transition temperature modifier such that 5 parts by weight or more and 50 parts by weight or less (i.e., from 5 parts by weight to 50 parts by weight) of the binder resin and 0.01 parts by weight or more and 5 parts by weight or less (i.e., from 0.01 parts by weight to 5 parts by weight) of the glass transition temperature modifier are mixed relative to 100 parts by weight of the inorganic powder.

The disclosure (12) is a chip-type multilayer electronic component comprising a base body including a plurality of ceramic fired sheets stacked on top of one another, wherein the base body has a striped pattern perpendicular to a stacking direction when viewed from a side surface.

### EXAMPLES

Examples, which more specifically disclose the composition of the present disclosure and the like, will be described below. The present disclosure is not limited to the following Examples.

### Examples

A ferrite powder (inorganic powder) was produced by mixing 50 parts by weight of pure water relative to 100 parts by weight of ferrite, 0.5 parts by weight of ammonium polycarboxylate (dispersant) relative to 100 parts by weight of ferrite, and ferrite, and grinding the resulting mixture with a ball mill.

Next, the ferrite powder, polyvinyl acetate (binder resin), and tris(2-ethylhexyl) trimellitate (glass transition temperature modifier) were blended at the proportions shown in Table 1 to produce a slurry-like composition according to Example.

Next, after defoaming the composition according to Example, the composition was applied in a sheet form to a PET film and dried with hot air to produce a sheet-like product (thickness: about 50 μm) according to Example.

### Comparative Example

A sheet-like product (thickness: about 50 μm) according to Comparative Example was produced in the same manner as in Examples except that tris(2-ethylhexyl) trimellitate (glass transition temperature modifier) was not used and the ferrite powder and polyvinyl acetate (binder resin) were blended in the proportions shown in Table 1 in the production of a slurry-like composition.

### Dynamic Viscoelasticity Measurement and Tg Calculation

Next, the sheet-like products according to each of Examples and Comparative Examples were pressure-bonded together to produce a multilayer body with a thickness of 500 μm.

Next, the multilayer body according to each of Examples and Comparative Example was cut to width×length=10 mm×50 mm and used as a test sample.

Next, the dynamic viscoelasticity was measured using the test sample according to each of Examples and Comparative Example.

The dynamic viscoelasticity was measured using a viscoelasticity analyzer (model: DMA7000, manufacturer: Hitachi High-Tech Corporation) in the measurement temperature range of −30° C. to 100° C.

Based on the results of the dynamic viscoelasticity measurement, the Tg of the binder resin contained in the composition according to each of Examples and Comparative Example was calculated.

The results are shown in Table 1.

TABLE 1

| | | | | | Comparative |
|---|---|---|---|---|---|
| | | Examples | | | Example |
| Binder resin | compound | polyvinyl acetate | | | polyvinyl acetate |
| | weight | 12.56 | 12.21 | 11.55 | 12.94 |
| | percentage | | | | |
| | (wt %) relative | | | | |
| | to ferrite | | | | |
| | powder | | | | |
| Glass transition | compound | tris(2-ethylhexyl) trimellitate | | | — |
| temperature | weight | 0.38 | 0.73 | 1.39 | — |
| modifier | percentage | | | | |
| | (wt %) relative | | | | |
| | to ferrite | | | | |
| | powder | | | | |

| | | | | |
|---|---|---|---|---|
| Glass transition temperature (° C.) | 27.1 | 29.5 | 32.0 | 22.0 |

Table 1 reveals that the use of tris(2-ethylhexyl) trimellitate as a glass transition temperature modifier increases the Tg of polyvinyl acetate contained in the composition.

### Relationship Between Amount of Glass Transition Temperature Modifier Used and Tg

Except that the ferrite powder, polyvinyl acetate (binder resin), and tris(2-ethylhexyl) trimellitate (glass transition temperature modifier) were blended at the proportions shown in Table 2, the Tg of polyvinyl acetate at each proportion was calculated in the same manner as in the “Dynamic Viscoelasticity Measurement and Tg Calculation” described above. The degree of increase in the Tg of polyvinyl acetate relative to the Tg of polyvinyl acetate in Comparative Example was evaluated based on the following criteria.

The results are shown in Table 2.

### Criteria for Evaluating Temperature Increase in Tg

The ratings A1 and A2 satisfy the following relationship formulas, where “T₀” denotes the Tg of polyvinyl acetate in Comparative Example and “Tₓ” denotes the Tg of polyvinyl acetate in each Example.

$$A 1 : 5 ° C . \leq ( {T}_{x} - {T}_{0} )$$

$$A 2 : ( {T}_{x} - {T}_{0} ) < 5 ° C .$$

TABLE 2

| | | Weight percentage (wt %) of | | | | |
|---|---|---|---|---|---|---|
| | | polyvinyl acetate relative to | | | | |
| | | weight of ferrite powder | | | | |
| | | 5.0 | 10.0 | 20.0 | 30.0 | 50.0 |
| Weight percentage | 0.01 | A2 | A2 | A2 | A2 | A2 |
| (wt %) of | 0.10 | A1 | A2 | A2 | A2 | A2 |
| bis(2-ethylhexyl) | 0.40 | A1 | A1 | A1 | A2 | A2 |
| adipate relative | 1.00 | A1 | A1 | A1 | A1 | A2 |
| to weight of | 1.4 | A1 | A1 | A1 | A1 | A2 |
| ferrite powder | 2.0 | A1 | A1 | A1 | A1 | A2 |
| | 4.0 | A1 | A1 | A1 | A1 | A2 |
| | 6.0 | A1 | A1 | A1 | A1 | A2 |
| | 10.0 | A1 | A1 | A1 | A1 | A2 |

The graph of the loss factor (Tan δ) in the dynamic viscoelasticity measurement in each Example was also examined to determine whether the peaks were separated.

The separation of the peaks suggests that polyvinyl acetate and tris(2-ethylhexyl) trimellitate are separated in the composition.

The evaluation criteria are as described below. The results are shown in Table 3.
B1: The peaks are not separated.
B2: The peaks are separated.

TABLE 3

| | | Weight percentage (wt %) of | | | | |
|---|---|---|---|---|---|---|
| | | polyvinyl acetate relative to | | | | |
| | | weight of ferrite powder | | | | |
| | | 5.0 | 10.0 | 20.0 | 30.0 | 50.0 |
| Weight percentage | 0.01 | B1 | B1 | B1 | B1 | B1 |
| (wt %) of | 0.10 | B1 | B1 | B1 | B1 | B1 |
| bis(2-ethylhexyl) | 0.40 | B1 | B1 | B1 | B1 | B1 |
| adipate relative | 1.00 | B2 | B1 | B1 | B1 | B1 |
| to weight of | 1.4 | B2 | B2 | B1 | B1 | B1 |
| ferrite powder | 2.0 | B2 | B2 | B2 | B1 | B1 |
| | 4.0 | B2 | B2 | B2 | B2 | B1 |
| | 6.0 | B2 | B2 | B2 | B2 | B2 |
| | 10.0 | B2 | B2 | B2 | B2 | B2 |

The graph of the loss factor (Tan δ) in the dynamic viscoelasticity measurement in FIG. 4 presents Example using 10 wt % polyvinyl acetate and 1.4 wt % tris(2-ethylhexyl) trimellitate as a representative example of peak separation.

FIG. 4 is the graph of the loss factor (Tan δ) in the dynamic viscoelasticity measurement in Example according to the present disclosure.

Referring to FIG. 4, the graph of the loss factor (Tan δ) in the dynamic viscoelasticity measurement in Example exhibits two peaks: one near 18° C. and the other near 48° C. The peak near 48° C. is considered to correspond to a peak of aggregates of polyvinyl acetate.

The presence of tris(2-ethylhexyl) trimellitate in the composition is considered to suppress orientation of the compound toward the acetyloxy groups of polyvinyl acetate molecules and cause the polyvinyl acetate molecules to associate with each other. This may increase the Tg of polyvinyl acetate.

However, if the proportion of tris(2-ethylhexyl) trimellitate is too high, the polyvinyl acetate molecules may associate with each other locally to form aggregates.

The formation of such aggregates may cause separation of the peaks as illustrated in FIG. 4.

Since the formation of such aggregates leads to a decrease in the strength of the sheet-like product or the multilayer body, such aggregates are preferably absent.

In the evaluation, Examples that satisfy both the ratings A1 and B1 can be rated as “Excellent,” and other Examples can be rated as “Available.” This evaluation is shown in Table 4.

TABLE 4

| | | Weight percentage (wt %) of | | | | |
|---|---|---|---|---|---|---|
| | | polyvinyl acetate relative to | | | | |
| | | weight of ferrite powder | | | | |
| | | 5.0 | 10.0 | 20.0 | 30.0 | 50.0 |
| Weight percentage | 0.01 | Available | Available | Available | Available | Available |
| (wt %) of | 0.10 | Excellent | Available | Available | Available | Available |
| bis(2-ethylhexyl) | 0.40 | Excellent | Excellent | Excellent | Available | Available |
| adipate relative | 1.00 | Available | Excellent | Excellent | Excellent | Available |
| to weight of | 1.4 | Available | Available | Excellent | Excellent | Available |
| ferrite powder | 2.0 | Available | Available | Available | Excellent | Available |
| | 4.0 | Available | Available | Available | Available | Available |
| | 6.0 | Available | Available | Available | Available | Available |
| | 10.0 | Available | Available | Available | Available | Available |

Tables 2 to 4 reveal that, by adjusting the ratio of polyvinyl acetate to tris(2-ethylhexyl) trimellitate, the Tg of polyvinyl acetate in the compositions according to Examples can be adjusted while avoiding separation between polyvinyl acetate and tris(2-ethylhexyl) trimellitate.

What is claimed is:

1. A composition comprising:
an inorganic powder;
a binder resin; and
a glass transition temperature modifier,
wherein the glass transition temperature modifier has a structure represented by a general formula (1) below: 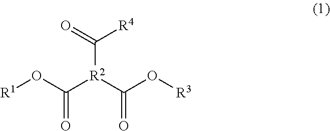
in the general formula (1), R¹ is a hydrogen atom or a C1-C12 hydrocarbon group,
in the general formula (1), R² is a C1-C12 hydrocarbon group,
in the general formula (1), R³ is a hydrogen atom or a C1-C12 hydrocarbon group, and
in the general formula (1), R⁴ is a hydrogen atom or a C1-C12 hydrocarbon group.

2. The composition according to claim 1, wherein
the glass transition temperature modifier is a derivative of at least one tricarboxylic acid selected from the group consisting of trimellitic acid, aconitic acid, propane-1,2,3-tricarboxylic acid, and cyclohexane-1,2,4-tricarboxylic acid.

3. The composition according to claim 1, further comprising:
a solvent.

4. The composition according to claim 1, wherein
the binder resin includes at least one selected from the group consisting of polyvinyl acetate, polyvinyl butyral, polyvinyl alcohol, acrylic, urethane, polyvinyl pyrrolidone, polyethylene glycol, ethylene-vinyl acetate copolymer, and cellulose ether.

5. The composition according to claim 1, wherein
the inorganic powder includes a ceramic powder.

6. The composition according to claim 1, wherein
the inorganic powder includes at least one selected from the group consisting of zirconia, titania, alumina, barium titanate, ferrite, lead zirconate titanate (PZT), zinc oxide, glass, and glass ceramics.

7. The composition according to claim 1, wherein,
relative to 100 parts by weight of the inorganic powder,
the binder resin is included in an amount of from 5 parts by weight to 50 parts by weight, and
a plasticizer is included in an amount of from 0.01 parts by weight to 5 parts by weight.

8. A sheet-like product comprising:
the composition according to claim 1.

9. A multilayer body comprising:
a plurality of the sheet-like products according to claim 8 stacked on top of one another.

10. A sheet-like product comprising:
the composition according to claim 2.

11. A sheet-like product comprising:
the composition according to claim 3.

12. A sheet-like product comprising:
the composition according to claim 4.

13. A sheet-like product comprising:
the composition according to claim 5.

14. A sheet-like product comprising:
the composition according to claim 6.

15. A sheet-like product comprising:
the composition according to claim 7.

16. A multilayer body comprising:
a plurality of the sheet-like products according to claim 10 stacked on top of one another.

17. A multilayer body comprising:
a plurality of the sheet-like products according to claim 11 stacked on top of one another.

18. A method for manufacturing a composition, the method comprising:
grinding an inorganic material into an inorganic powder; and
mixing the inorganic powder, a binder resin, and a glass transition temperature modifier,
wherein the glass transition temperature modifier includes a compound having a structure represented by general formula (1) below: 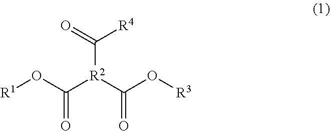
in general formula (1), R¹ is a hydrogen atom or a C1-C12 hydrocarbon group,
in general formula (1), R² is a C1-C12 hydrocarbon group,
in general formula (1), R³ is a hydrogen atom or a C1-C12 hydrocarbon group, and
in general formula (1), R⁴ is a hydrogen atom or a C1-C12 hydrocarbon group.

19. The method for manufacturing a composition according to claim 18, wherein
the mixing includes mixing the inorganic powder, the binder resin, and the glass transition temperature modifier such that from 5 parts by weight to 50 parts by weight of the binder resin and from 0.01 parts by weight to 5 parts by weight of the glass transition temperature modifier are mixed relative to 100 parts by weight of the inorganic powder.

20. A chip-type multilayer electronic component comprising:
a base body including a plurality of ceramic sheets stacked on top of one another and fired,
wherein the base body has a striped pattern perpendicular to a stacking direction when viewed from a side surface of the base body.
